(19) United States
(12) Patent Application Publication
(10) Pub. No.: US 2026/0020056 A1
(43) Pub. Date: Jan. 15, 2026

(54) METHODS, DEVICES AND COMPUTER READABLE MEDIA FOR COMMUNICATIONS

(71) Applicant: Nokia Technologies Oy, Espoo (FI)

(72) Inventors: Yong LIU, Shanghai (CN); Tao TAO, Shanghai (CN); Jian Guo LIU, Shanghai (CN); Yan MENG, Shanghai (CN)

(21) Appl. No.: 18/995,448

(22) PCT Filed: Jul. 18, 2022
(86) PCT No.: PCT/CN2022/106340

§ 371 Date: Jan. 16, 2025

(51) Int. Cl. H04W 74/0808; H04W 64/00; H04W 72/25

(52) U.S. Cl. CPC H04W 74/0808; H04W 64/00; H04W 72/25

(57) ABSTRACT

Embodiments of the present disclosure relate to method, device and computer readable media for communications. A first device performs a first type LBT procedure in unlicensed band. In response to a successful performing of the first type LBT procedure, the first device transmits, to a second device, a first sidelink positioning reference signal (PRS) sequence in the unlicensed band for ranging between the first device and the second device, and/or for positioning of the first device. The first sidelink PRS sequence is associated with the first type LBT procedure and/or a second type LBT procedure to be performed by the second device for transmitting a second sidelink PRS sequence in the unlicensed band to the first device for the ranging or the positioning.

### TECHNICAL FIELD

Implementations of the present disclosure generally relate to the field of telecommunication, and in particular, to methods, devices and computer readable media for communications.

### BACKGROUND

Communication systems enable vehicle to everything (V2X) and device to device (D2D) communications to be performed. V2X communications may be based on communication technologies such as sidelink communication technologies. For this, sidelink resource pools and sidelink channels can be established for vehicles participating in such communications.

### SUMMARY

In general, example implementations of the present disclosure provide a method, device and computer readable medium for communications.

In a first aspect, there is provided a first device. The first device includes at least one processor and at least one memory including computer program codes. The at least one memory and the computer program codes are configured to, with the at least one processor, cause the first device to: perform a first type listen before talk (LBT) procedure in an unlicensed band; in response to a successful performing of the first type LBT procedure, transmit, to a second device, a first sidelink positioning reference signal (PRS) sequence in the unlicensed band for ranging between the first device and the second device, and/or for positioning of the first device. The first sidelink PRS sequence is associated with the first type LBT procedure and/or a second type LBT procedure to be performed by the second device for transmitting a second sidelink PRS sequence in the unlicensed band to the first device for the ranging or the positioning.

In a second aspect, there is provided a second device. The second device includes at least one processor and at least one memory including computer program codes. The at least one memory and the computer program codes are configured to, with the at least one processor, cause the second device to: detect a first sidelink PRS sequence transmitted in an unlicensed band by a first device for ranging between the first device and the second device, and/or for positioning of the first device; determine, based on the first sidelink PRS sequence, a first type LBT procedure performed by the first device for the transmission of the first sidelink PRS sequence in the unlicensed band; determine, based on the first type LBT procedure, a second type LBT procedure; and perform the second type LBT procedure for transmission of a second sidelink PRS sequence in the unlicensed band to the first device for the ranging or the positioning.

In a third aspect, there is provided a method implemented at a first device. The method includes: performing, by a first device, a first type LBT procedure in an unlicensed band; and in response to a successful performing of the first type LBT procedure, transmitting, to a second device, a first sidelink PRS sequence in the unlicensed band for ranging between the first device and the second device, and/or for positioning of the first device, wherein the first sidelink PRS sequence is associated with the first type LBT procedure and/or a second type LBT procedure to be performed by the second device for transmitting a second sidelink PRS sequence in the unlicensed band to the first device for the ranging or the positioning.

In a fourth aspect, there is provided a method implemented at a second device. The method includes: detecting, by a second device, a first sidelink PRS sequence transmitted in an unlicensed band by a first device for ranging between the first device and the second device, and/or for positioning of the first device; determining, based on the first sidelink PRS sequence, a first type LBT procedure performed by the first device for the transmission of the first sidelink PRS sequence; determining, based on the first type LBT procedure, a second type LBT procedure; and performing the second type LBT procedure for transmission of a second sidelink PRS sequence in the unlicensed band to the first device for the ranging or the positioning.

In a fifth aspect, there is provided an apparatus. The apparatus includes: means for performing, by a first device, a first type LBT procedure in an unlicensed band; and means for transmitting, to a second device, a first sidelink PRS sequence in the unlicensed band for ranging between the first device and the second device, and/or for positioning of the first device, in response to a successful performing of the first type LBT procedure, wherein the first sidelink PRS sequence is associated with the first type LBT procedure and/or a second type LBT procedure to be performed by the second device for transmitting a second sidelink PRS sequence in the unlicensed band to the first device for the ranging or the positioning.

In a sixth aspect, there is provided an apparatus. The apparatus includes: means for detecting, by a second device, a first sidelink PRS sequence transmitted by a first device in an unlicensed band for ranging between the first device and the second device, and/or for positioning of the first device; means for determining, based on the first sidelink PRS sequence, a first type LBT procedure performed by the first device for the transmission of the first sidelink PRS sequence; means for determining, based on the first type LBT procedure, a second type LBT procedure; and means for performing the second type LBT procedure for transmission of a second sidelink PRS sequence in the unlicensed band to the first device for the ranging or the positioning.

In a seventh aspect, there is provided a non-transitory computer readable medium. The non-transitory computer readable medium includes program instructions for causing an apparatus to perform the method according to the third aspect.

In an eighth aspect, there is provided a non-transitory computer readable medium. The non-transitory computer readable medium includes program instructions for causing an apparatus to perform the method according to the fourth aspect.

It is to be understood that the summary section is not intended to identify key or essential features of implementations of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some implementations of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example of a clear channel assessment (CCA) slot in accordance with some implementations of the present disclosure;

FIG. 3 illustrates an example of acquisition of channel occupancy time (COT) in accordance with some implementations of the present disclosure;

FIG. 4 illustrates an example of a contention window countdown procedure in accordance with some implementations of the present disclosure;

FIGS. 5A and 5B illustrate an example of allowed gaps for which Type 2 LBT procedures to be applicable in accordance with some implementations of the present disclosure, respectively;

FIG. 6 illustrates an example of an initiating device communicating through sidelink (SL) with a plurality of responding devices under respectively acquired COTs using different types of LBT procedures according to an implementation;

FIG. 7 illustrates a signaling chart illustrating a process for ranging or positioning in accordance with some implementations of the present disclosure;

FIGS. 8A, 8B and 8C illustrate an example of a frame structure for transmission of a first sidelink PRS sequence in accordance with some implementations of the present disclosure, respectively;

FIG. 9 illustrates a flowchart of an example method in accordance with some implementations of the present disclosure;

FIG. 10 illustrates a flowchart of another example method in accordance with some implementations of the present disclosure;

FIG. 11 illustrates a flowchart of an example method in accordance with other implementations of the present disclosure;

FIG. 12 illustrates a simplified block diagram of an apparatus that is suitable for implementing embodiments of the present disclosure; and

FIG. 13 illustrates a block diagram of an example computer readable medium in accordance with some implementations of the present disclosure.

Throughout the drawings, the same or similar reference numerals represent the same or similar element.

### DETAILED DESCRIPTION

Principle of the present disclosure will now be described with reference to some example implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “includes”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Implementations of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

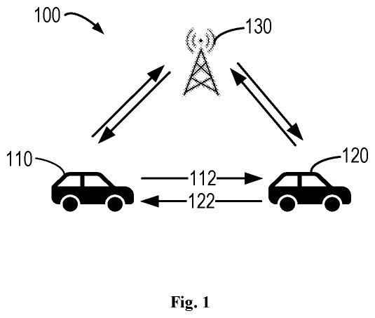

FIG. 1 illustrates a schematic diagram of an example communication network 100 in which implementations of the present disclosure can be implemented. As shown in FIG. 1. the communication network 100 may include a first device 110, a second device 120 and a third device 130. The third device 130 may communicate with the first device 110 and the second device 120 via respective wireless communication channels.

In this example, only for ease of discussion, the first device 110 and the second device 120 are illustrated as vehicles which enable V2X communications and the third device 130 is illustrated as a network device serving the vehicles 110 and 120. It is to be understood that the vehicles and the network device are only example implementations of the first device 110, the second device 120 and the third device 130, respectively, without suggesting any limitation as to the scope of the present application. Any other suitable implementations are possible as well.

It is to be understood that the number of devices (110, 120, 130) in FIG. 1 is given for the purpose of illustration without suggesting any limitations to the present disclosure. The communication network 100 may include any suitable number of devices adapted for implementing implementations of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In an example, communication between the first device 110 and the second device 120 may be performed in new radio (NR) operation in an unlicensed band. In some implementations, the communications in the communication network 100 may include sidelink (SL) communication (112, 122). In sub-7 GHz unlicensed bands, the new radio (NR) coexistence with other systems (e.g. IEEE 802.11) may be ensured via a Listen Before Talking (LBT) channel access mechanism. According to the channel access mechanism, a user equipment (UE) (i.e., device 110 or device 120) intending to perform an SL transmission (112 or 122) may need first to successfully complete an LBT check, before being able to initiate the same SL transmission. Hereinafter, an LBT procedure may also be referred to as Clear Channel Assessment (CCA) or channel access procedure.

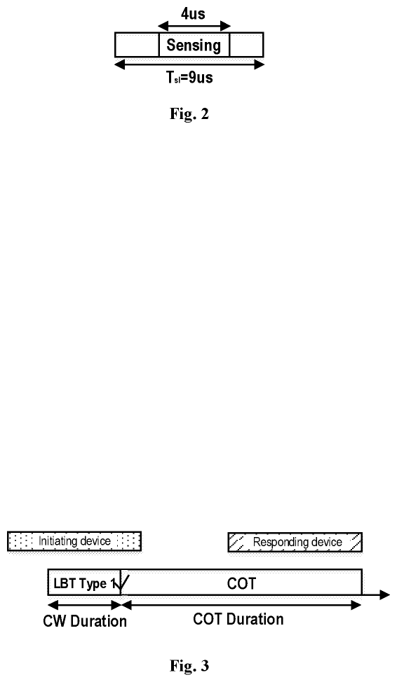

For a UE to pass an LBT check, it must observe the channel as available for a number of consecutive CCA slots. In sub-7 GHz, the duration of these slots is 9 μs, as depicted in FIG. 2. FIG. 2 shows that CCA slot may have a duration Tₛₗ=9 us, where the energy sensing takes place during 4 us. The UE deems the channel as available in a CCA slot if the measured power (i.e. the collected energy during the CCA slot) is below a regulatory specified threshold which may depend on the operating band and geographical region.

In an example, when a UE (e.g., device 110) takes a role of an initiating device to initiate a communication with a responding device (e.g., device 120), this initiating UE (device 110) may need to acquire the “right” to access the channel for a certain period of time—as denoted in the regulations as the Channel Occupancy Time (COT)—by applying an “extended” LBT procedure where the channel must be deemed as free for the entire duration of a Contention Window (CW). This “extended” LBT procedure is commonly known as a Type 1 LBT procedure or LBT Type 1 procedure as specified in TS 37.213. This procedure is illustrated in FIG. 3.

Both of a CW duration and a COT duration in FIG. 3 may depend on the Channel Access Priority Class (CAPC) associated with the UE's traffic (e.g., p=1 to p=4), as shown in Table 1. Control plane traffic (such as physical sidelink control channel (PSCCH)) may be transmitted with a priority of p=1, while user plane traffic has a priority of p>1. Table 1 depicts details of the Type 1 LBT for the Uu uplink (UL) case. It may be noted that in the downlink (DL) case, Type 1 LBT parameters may also in principle be adopted in SL.

TABLE 1

| Channel | | | | | |
|---|---|---|---|---|---|
| Access | | | | | |
| Priority | | | | | |
| Class (p) | mₚ | CW_{min, p} | CW_{max, p} | T_{ulm cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 us. The maximum duration before including any such gap shall be 6 ms.

Table 1 shows CAPC for UL. The contention window length in CCA slots associated with each CAPC has a minimum (CW_{min, p}) and maximum (CW_{max, p}). The duration of the COT is given by T_{ulm cot, p}.

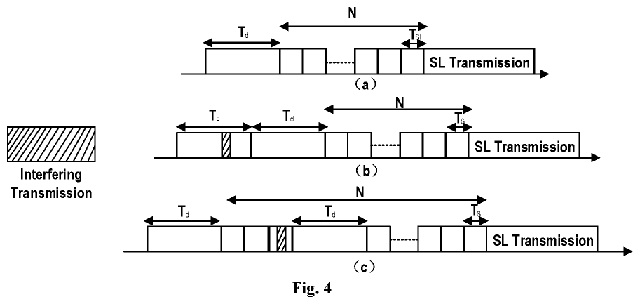

Examples of behavior during the contention window countdown procedure are depicted in FIG. 4. It should be noted that if during the countdown procedure the LBT check fails in any CCA slot, the countdown procedure will stop and will only resume if the channel is deemed as free (i.e. the LBT check is successful) during a defer time.

In FIG. 4. T_{d} represents the defer time, Tₛₗ represents the CCA slot duration and N represents the number of CCA slots required to be deemed as free before the contention window countdown is completed. Specifically, FIG. 4 shows a Type 1 LBT contention window countdown procedure and examples on how it can be disrupted. In example (a), when neither the defer time T_{d} nor the countdown are disrupted (i.e., the channel is not detected as busy during a sensing slot). In example (b), the defer time T_{d} is disrupted (i.e., the channel is detected as busy during a defer time sensing slot). In example (c), the contention window countdown is disrupted (i.e., the channel is detected as busy during a sensing slot of the countdown).

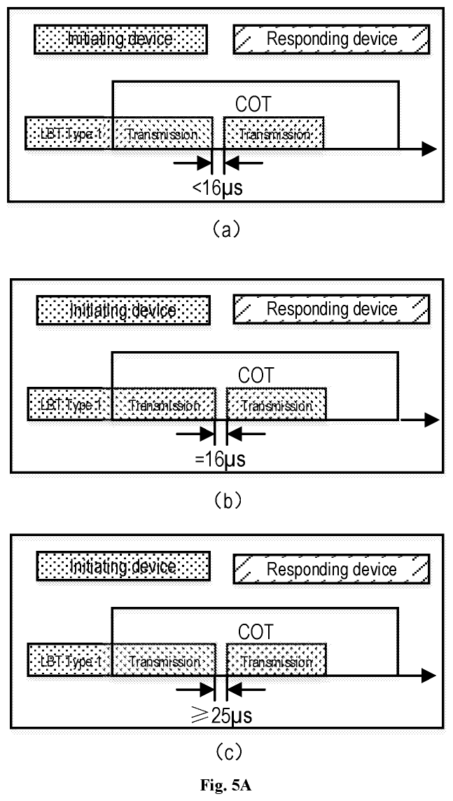

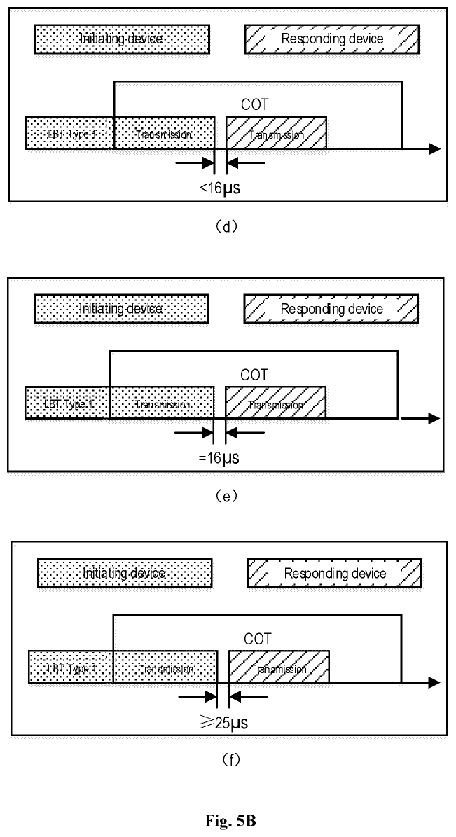

The UE initiating the transmission (also referred to as the initiating device, e.g., device 110) upon successfully completing performing the Type 1 LBT procedure and performing a transmission (e.g., to device 120), may acquire the COT with duration associated with a priority p in the corresponding CAPC. The acquired COT may be valid even in the case where the initiating device (e.g., device 110) may pause its transmission (e.g., to device 120), although if the initiating device wants to perform a new transmission (e.g., to device 120) (within the COT) it may still be required to perform a “reduced” LBT procedure. This “reduced” LBT procedure is commonly known as a Type 2 LBT procedure or LBT Type 2 procedure with the following variants:
Type 2A (25 μs LBT)—for SL transmissions within a COT that the initiating device acquires (in case the gap between two SL transmissions is ≥25 μs, as well for SL transmissions following another SL transmission), as depicted in example (c) in FIG. 5A and example (f) in FIG. 5B;
Type 2B (16 μs LBT)—for SL transmission within a COT that the initiating device acquires (can only be used for SL transmissions following another SL with a gap exactly equal to 16 μs), as depicted in example (b) in FIG. 5A and example (c) in FIG. 5B;
Type 2C (no LBT)—which can only be used for SL transmission following another SL, with a gap <16 μs and the allowed duration of the SL transmission ≤584 μs, as depicted in example (a) in FIG. 5A and example (d) in FIG. 5B.

In addition, the examples (a), (b) and (c) show the case where the gap is between the two transmissions both from the same initiating UE (i.e., device 110), while the examples (d), (c), and (f) show the case that the gap is between the two different transmissions from the initiating UE (e.g., device 110) and the responding UE (e.g., device 120), correspondingly.

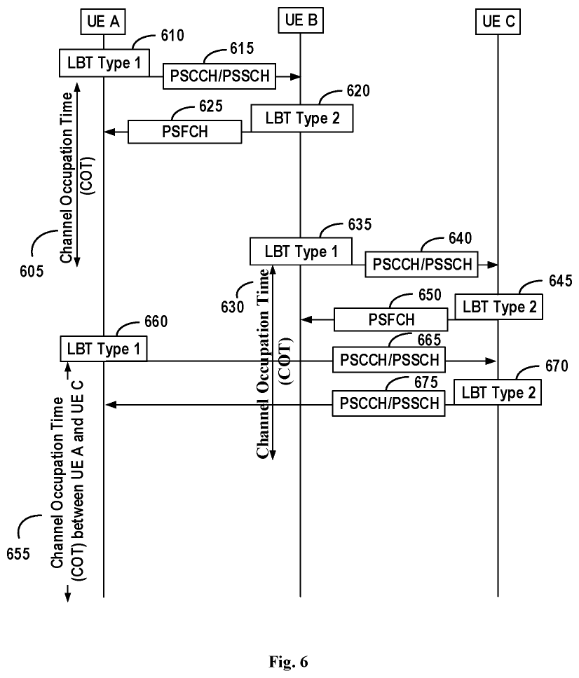

The initiating device (e.g., device 110) may share its acquired COT with its intended receiver (also referred to as the responding device (e.g., device 120)). For this purpose, the initiating device (e.g., device 110) shall inform (e.g. via control signaling) the responding device (e.g., device 120) about the duration of this COT. The responding device then uses this information to decide which type of LBT procedure it should apply upon performing a transmission for which the intended receiver is the initiating device. In case the responding device transmission falls outside the COT, then the responding device (e.g., device 120) will have to acquire a new COT using the Type 1 LBT with an appropriate class p in the CAPC. This will be described with reference to FIG. 6.

FIG. 6 illustrates an example of an initiating device communicating through sidelink (SL) with a plurality of responding devices under respectively acquired COTs using different types of LBT procedures, according to an implementation. According to FIG. 6, an initiating device (i.e., UE A) may first acquire a new COT 605 using a Type 1 LBT procedure 610. The initiating device (UE A) may then transmit through a sidelink (SL) transmission 615 on PSCCH and/or physical sidelink shared channel (PSSCH) to a first responding device (UE B). In addition, UE A may share its acquired COT 605 with UE B. UE B may then use this acquired COT 605 information to decide which type of LBT procedure it should apply when performing a transmission to UE A as an intended receiver. In practice, UE A may inform (e.g. via control signaling) UE B about a duration of the COT 605 within the SL transmission 615. In response, UE B may be configured to perform a Type 2 LBT procedure 620 and transmit SL feedback information 625 to UE A, on the PSFCH.

Alternately, UE B may communicate with another responding device (e.g., UE C). In case if a transmission from UE B to UE C falls outside the duration of the COT 605, UE B may need to acquire a new COT 630 using the Type 1 LBT procedure 635 according to an appropriate class p in the CAPC. UE B may then transmit SL transmission 640 on the PSCCH and/or PSSCH to UE C and share its acquired COT 630 with UE C. UE C may use the COT 630 information to decide which type of LBT procedure UE C should apply when performing a transmission to UE B as the intended receiver. In practice, UE B may inform (e.g. via control signaling) UE C about the duration of the COT 630 within the SL transmission 640. In response, UE C may be configured to perform a Type 2 LBT procedure 645 and transmit SL feedback information 650 to UE B on the PSFCH.

In case if UE A wants to perform a transmission to UE C. then UE A may need to acquire another new COT 655 using the Type 1 LBT procedure 660 with an appropriate CAPC. For example, UE A may need to acquire the new COT 655 using a Type 1 LBT procedure 660 with an appropriate class p in the CAPC. UE A may transmit SL transmission 665 on PSCCH and/or PSSCH to UE C. In addition, UE A may also share the duration in the acquired COT 655 with UE C (e.g. via control signaling). UE C may then use this duration information of the COT 655 to decide which type of LBT procedure UE C should apply when performing a transmission to UE A as the intended receiver. Upon receiving the SL transmission 665 with the duration information of the COT 655, UE C may successfully perform a Type 2 LBT procedure 670 and transmits SL feedback information 675 on PSFCH to UE A.

In an embodiment, sidelink ranging or positioning in an unlicensed band may be carried out by the different devices UE A and UE B (or device 110 and device 120). For example, timing estimation based on round trip time (RTT) may be considered as a suitable method for sidelink ranging or positioning since the first device 110 and the second device 120 (i.e., responding devices) are usually not well synchronized. Retuning to FIG. 1, for ranging or positioning between the first device 110 and the second device 120 by employing RTT, the first device 110 may transmit a first sidelink positioning reference signal sequence 112 (PRS_t) to the second device 120 and then receives a second sidelink PRS sequence 122 (PRS_s) from the second device 120 in order to estimate the RTT.

Accuracy of the RTT-based timing estimation may depend on the bandwidth of PRS transmission. At least 100 MHz may be needed for sub-meter positioning accuracy. Licensed band such as ITS band cannot provide such a large bandwidth. However, unlicensed band can provide such a large bandwidth. Thus, for the ranging or positioning, the first device 110 and the second device 120 may transmit respective first sidelink PRS sequences 112 (PRS_t) and the second sidelink PRS sequence 122 (PRS_s) in an unlicensed band.

In the unlicensed band, the first device 110 and the second device 120 may need to access the channel quickly to finish transmissions of the first and second sidelink PRS sequences 112 (PRS_t) and 122 (PRS_s) for fast ranging or positioning.

Implementations of the present disclosure (see FIG. 7) may provide a solution for sidelink ranging or positioning so as to solve the above problems and one or more of other potential problems. According to the solution, a first device (UE A) may perform a first type LBT procedure. In response to a successful performing of the first type LBT procedure, the first device (UE A) may transmit, to a second device (UE B), a first sidelink PRS sequence (PRS_t) in unlicensed band for ranging or positioning between the first device (UE A) and the second device (UE B). The first sidelink PRS sequence (PRS_t) is not only used for ranging or positioning related estimation such as timing estimation but also conveys information (see Table 2) about the first type LBT procedure which the first device applied to acquire the channel in unlicensed band and about a second type LBT procedure which the second device (UE B) should apply to acquire the channel later. Upon receiving the first sidelink PRS sequence (PRS_t), the second device (UE B) may determine the second type LBT procedure based on the first sidelink PRS sequence (PRS_t). In this way, latency of PRS sequence transmissions (PRS_t and PRS_s) in unlicensed band may be reduced and fast ranging or positioning may be achieved.

Hereinafter, principle of the present disclosure will be described with reference to FIGS. 7 to 13.

FIG. 7 illustrates a signaling chart illustrating a process 700 for sidelink ranging or positioning in accordance with some example embodiments of the present disclosure. For the purpose of discussion, the process 700 will be described with reference to FIG. 1. The process 700 may involve the first device 110 and the second device 120 as illustrated in FIG. 1. Although the process 700 will be described in the communication network 100 of FIG. 1, this process may be likewise applied to other communication scenarios.

For example, the third type LBT procedure may be the Type 1 LBT procedure as described above, and the first type LBT procedure may be a 25 us LBT procedure which will be described below with reference to Table 2. In this example, upon determining the Type 1 LBT procedure cannot be completed successfully before the transmission of the first sidelink PRS sequence, the first device 110 may switch to the 25 us LBT procedure. Thus, latency of the transmission of the first sidelink PRS sequence may be reduced.

It will be understood that each of the first type LBT procedure and the third type LBT procedure may be any type of LBT procedure, as long as the third type LBT procedure is different from the first type LBT procedure.

As shown, the first device 110 may perform (step 730) a first type LBT procedure, in unlicensed band.

The first device 110 may determine (step 740) whether the first type LBT procedure (step 730) is performed successfully. If the first type LBT procedure is performed (step 730) successfully, the first device 110 may transmit (step 750), to the second device 120, a first sidelink PRS sequence (PRS_t) in unlicensed band. The first sidelink PRS sequence (PRS_t) may be used for ranging or positioning between the first device 110 and the second device 120. The first sidelink PRS sequence (PRS_t) may be associated with the first type LBT procedure and a second type LBT procedure to be performed by the second device 120 for transmitting (step 795) a second sidelink PRS sequence (PRS_s) to the first device 110 in unlicensed band for the ranging or the positioning.

Alternatively, the first sidelink PRS sequence (PRS_t) may be associated with the first type LBT procedure or a second type LBT procedure to be performed by the second device 120 for transmitting the second sidelink PRS sequence (PRS_s) to the first device 110 in unlicensed band.

In some implementations, the second sidelink PRS sequence (PRS_s) may be used for the ranging or the positioning between the first device 110 and the second device 120.

Accordingly, the second device 120 detects (step 760) the first sidelink PRS sequence (PRS_t) transmitted by the first device 110 (step 750). The second device 120 may determine (step 770), based on the first sidelink PRS sequence (PRS_t), the first type LBT procedure which was performed by the first device 110 for the transmission of the first sidelink PRS sequence.

The second device 120 determines (step 780), based on the first type LBT procedure, a second type LBT procedure to be performed. In turn, the second device 120 performs (step 790) the second type LBT procedure for transmission (step 795) of the second sidelink PRS sequence (PRS_s) to the first device 110 in unlicensed band for the ranging or positioning. If the second type LBT procedure succeeds, the second device 120 transmits (step 795) the second sidelink PRS sequence (PRS_s) the first device 110. Otherwise, the second device 120 may not transmit any sidelink PRS sequence.

With the process 700, latency of PRS sequence transmissions (steps 750, 795) in unlicensed band may be reduced and fast ranging or positioning may be achieved.

With continued reference to FIG. 7, in some implementations, before performing (step 730) the first type LBT procedure, the first device 110 may perform (step 710) a third type LBT procedure in unlicensed band. The third type LBT procedure may be different from the first type LBT procedure. In turn, the first device 110 may determine (step 720) whether the third type LBT procedure may be completed successfully before the transmission (step 750) of the first sidelink PRS sequence (PRS_t).

In some implementations, the first device 110 determines, based on a value of a backoff counter, whether the third type LBT procedure may be completed successfully before the transmission (step 750) of the first sidelink PRS sequence (PRS_t).

Consider an example. In this example, an initial value (V=Vᵢ) of the backoff counter is set to be seven. The first device 110 may perform the third type LBT procedure every 9 us. If the first device 110 determines the channel is free by performing the third type LBT procedure, the value of the backoff counter will be decreased by one (V=Vᵢ−1). If the value of the backoff counter is decreased to be zero (V=0) and the channel is free, the first device 110 may transmit (step 750) the first sidelink PRS sequence (PRS_t). However, if there is 30 us before the transmission of the first sidelink PRS sequence and the current value (V) of the backoff counter is equal to 4, the first device 110 may determine that the third type LBT procedure may not be completed successfully before the transmission (step 750) of the first sidelink PRS sequence (PRS_t).

If the third type LBT procedure cannot be completed successfully before the transmission (step 750) of the first sidelink PRS sequence (PRS_t), the first device 110 performs (step 730) the first type LBT procedure. For example, the third type LBT procedure may the Type 1 LBT procedure as described above, and the first type LBT procedure may a 25 us LBT procedure which will be described below with reference to Table 2. In this example, upon determining the Type 1 LBT procedure cannot be completed successfully before the transmission of the first sidelink PRS sequence, the first device 110 switches to the 25 us LBT procedure. Thus, latency of the transmission of the first sidelink PRS sequence may be reduced.

It will be understood that each of the first type LBT procedure and the third type LBT procedure may be any type LBT procedure, as long as the third type LBT procedure is different from the first type LBT procedure.

Table 2 shows an example of a first mapping among the first sidelink PRS sequence, the first type LBT procedure and the second type LBT procedure.

TABLE 2

| The first sidelink PRS | The first type | The second type |
|---|---|---|
| sequence (PRS_t) | LBT procedure | LBT procedure |
| Sequence #1 (PRS_t(sqn1)) | Type 1 LBT | Type 2C LBT |
| Sequence #2 (PRS_t(sqn2)) | 25 us LBT | 25 us LBT |
| Sequence #3 (PRS_t(sqn3)) | 25 us LBT | Type 1 LBT |
| Sequence #4 (PRS_t(sqn4)) | Type 2A LBT | Type 2A LBT |

Table 2 illustrates a mapping table associating the first type LBT procedure and the second type LBT procedure to a plurality of available PRS sequences (e.g., PRS_t(sqn1) to PRS_t(sqn4)) provided in the first sidelink PRS sequence (PRS_t). The mapping information in Table 2 may be practiced by the embodiments or examples illustrated in FGIS. 1, 7 and 9-11. As shown in Table 2, for example, if the first device 110 performs a Type 1 LBT procedure (also referred to as the extended LBT procedure) successfully, the first device 110 transmits a sidelink PRS sequence #1 (PRS_t(sqn1)) provided in the first sidelink PRS sequence (PRS_t) to the second device 120. Because the first device 110 may acquire a channel by performing the Type 1 LBT procedure successfully, the first device 110 may share COT to the second device 120 by transmitting (i.e., PSCCH/PSSCH), to the second device 120, sharing information about the COT. For example, the sharing information about the COT may indicate an identity of a device (e.g., device 120 or UE B) which is allowed to use the shared COT, a duration of the COT and so on.

Correspondingly, if the sequence #1 (PRS_t(sqn1)) is detected by the second device 120, the second device 120 may determine that the Type 1 LBT procedure (also referred to as the extended LBT procedure) was performed by the first device 110 for the transmission of the sequence #1. In addition, the second device 120 may determine that a Type 2C LBT procedure is to be performed by the second device 120 for the transmission of the second sidelink PRS sequence (PRS_s) to the first device 110. In other words, no more LBT procedure needs to be performed by the second device 120. This may cause the transmission of the second sidelink PRS sequence (PRS_s) to follow the transmission of the first sidelink PRS sequence (PRS_t) immediately.

In addition, based on a determination that the Type 1 LBT procedure was performed by the first device 110, the second device 120 may determine that the sharing information about the COT can be used. In other words, the second device 120 may determine that the COT is actually shared by the first device 110. In turn, the second device 120 may perform the Type 2C LBT procedure based on the sharing information about the COT. For example, the second device 120 may perform the Type 2C LBT procedure within the duration of the COT.

For a further example, if the first device 110 performs a 25 us LBT procedure (i.e., a first type LBT procedure) successfully, the first device 110 may transmit a sidelink PRS sequence #2 (i.e., PRS_t(sqn2)) to the second device 120. In an example when the first device 110 acquires the channel by successfully performing the 25 us LBT procedure, similar to transmission of NR-U discovery reference signal (DRS), the first device 110 may employ a short control signaling transmission to transmit the sequence #2 (PRS_t(sqn2)). As seen in this example, the first device 110 cannot share the COT to the second device 120. In addition, the use of the short control signaling transmission is constrained as follows:
within an observation period of 50 ms, the number of short control signaling transmissions by one or more devices shall be equal to or less than 50; and
the total duration of the short control signaling transmissions shall be less than 2500 us within an observation period.

In a case that the sequence #2 (PRS_t(sqn2)) is detected by the second device 120, the second device 120 may determine that the 25 us LBT procedure was performed by the first device 110 for the transmission of the sequence #2 (PRS_t(sqn2)). In addition, the second device 120 may determine that a 25 us LBT procedure (i.e., a second type LBT procedure) may also be performed by the second device 120 for the transmission of the second sidelink PRS sequence (PRS_s).

Yet in another example, the first device 110 (a responding device) may employ a COT initiated and shared by yet one or more another device (one or more another initiating device not shown in FIG. 1). In this example, the first device 110 may perform a Type 2A LBT procedure. If the Type 2A LBT procedure succeeds, the first device 110 transmits a sidelink PRS sequence #4 (i.e., (PRS_t(sqn4)) in the first PRS sequence) to the second device 120.

Correspondingly, if the sequence #4 (PRS_t(sqn4)) may be detected by the second device 120, the second device 120 may determine that the Type 2A LBT procedure (i.e., a first type LBT procedure) be performed by the first device 110 for a transmission of a sequence #4 (PRS_t (sqn4)) in the first sidelink PRS sequence. In addition, the second device 120 may determine that the Type 2A LBT procedure (i.e., a second type LBT procedure) is to be performed by the second device 120 for the transmission of the second sidelink PRS sequence (PRS_s).

Alternatively, a first mapping may be among the first sidelink PRS sequence (PRS_t), the first type LBT procedure and a set of second type LBT procedures. For example, a first sidelink PRS sequence (PRS_t) may be associated with a set of second type LBT procedures. The second device 120 may determine a second type LBT procedure from a set of second type LBT procedures.

Table 1 just provides an example of the first mapping among the first sidelink PRS sequences (PRS_t(sqn1) to PRS_t(sqn4)), the first type LBT procedure and the second type LBT procedure without suggesting any limitations to the scope of the present disclosure. A PRS sequence may be mapped to any suitable type of LBT procedure.

In some implementations, each of the first device 110 and the second device 120 may receive, from a network device 130, information about a first mapping among the first sidelink PRS sequence (PRS_t), the first type LBT procedure and the second type LBT procedure.

Alternatively, in some implementations, the first mapping among the first sidelink PRS sequence (PRS_t), the first type LBT procedure and the second type LBT procedure may be predefined.

Alternatively, in some implementations, the first device 110 may configure the second device 120 with information about the first mapping among the first sidelink PRS sequence (PRS_t), the first type LBT procedure and the second type LBT procedure.

In some implementations, as shown in FIG. 7, prior to transmitting to the second device 120 the first sidelink PRS sequence (PRS_t), the first device 110 may transmit (step 705), to the second device 120, information about at least one of the following: a first resource reservation for the transmission of the first sidelink PRS sequence (PRS_t), a second resource reservation for the transmission of the second sidelink PRS sequence (PRS_s) or the first mapping among the first sidelink PRS sequence, the first type LBT procedure and the second type LBT procedure.

For example, the information about the first resource reservation may include at least one of the following: a starting symbol (for example, a symbol s₁ in slot t₁) for the transmission of the first sidelink PRS sequence (PRS_t), or a duration of the transmission of the first sidelink PRS sequence (PRS_t). The information about the second resource reservation may include at least one of the following: a starting transmission symbol (for example, a symbol s₂ in slot t₁), or a transmission duration of the second sidelink PRS sequence.

In such implementations, the second device 120 may detect the first sidelink PRS sequence based on the information about the first resource reservation. In addition, the second device 120 may transmit the second sidelink PRS sequence based on the information about the second resource reservation.

In some implementations, before transmitting the first sidelink PRS sequence (PRS_t), the first device 110 may transmit the information about at least one of the first and second resource reservations or the first mapping in licensed band.

In some implementations, the first device 110 may transmit the information about at least one of the first and second resource reservations or the first mapping in sidelink control information (SCI) carried in a PSCCH or PSSCH. Alternatively, the first device 110 may transmit the information about at least one of the first and second resource reservations or the first mapping in a medium access control (MAC) control element (CE) carried in the PSSCH.

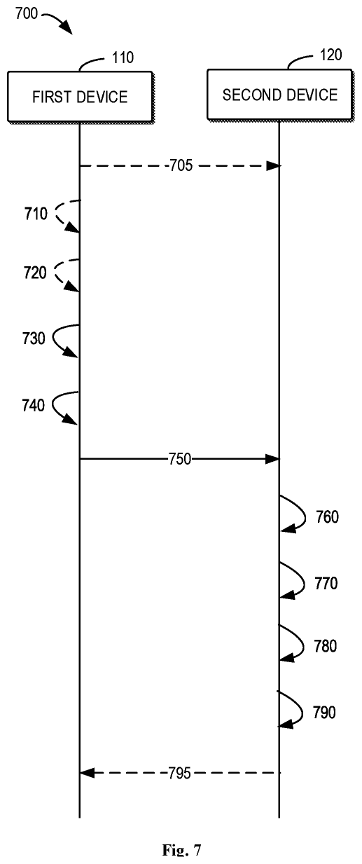

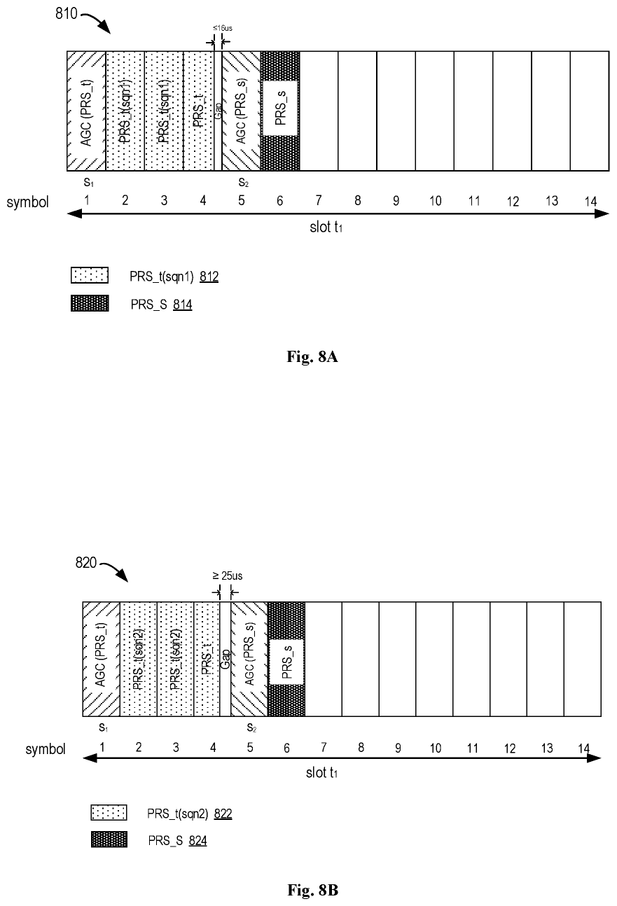

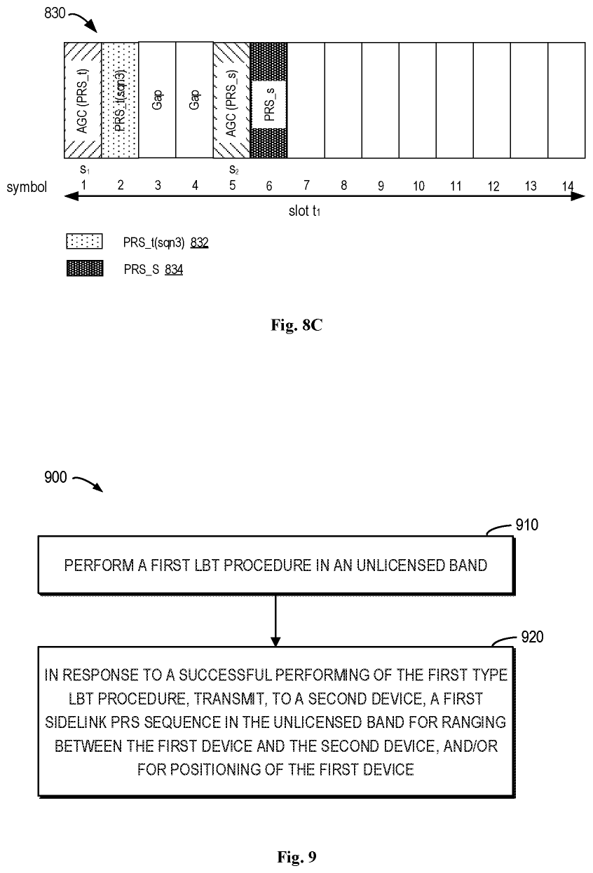

In some implementations, the first sidelink PRS sequence may be associated with a frame structure (e.g., anyone of 810, 820, 830) for the transmission of the first sidelink PRS sequence (PRS_t), and the frame structure may be associated with the second type LBT procedure. In such implementations, the second the second device 120 may determine the frame structure based on the first sidelink PRS sequence (PRS_t). In addition, the second device 120 may determine, based on the first type LBT procedure and the frame structure, the second type LBT procedure to be performed. This will be described with reference to Table 3 and FIGS. 8A to 8C.

Table 3 shows an example of a second mapping among the first sidelink PRS sequence (PRS_t), the first type LBT procedure, the frame structure and the second type LBT procedure.

TABLE 3

| The first | | | |
|---|---|---|---|
| sidelink PRS | The first type | The frame | The second type |
| sequence PRS_t | LBT procedure | structure | LBT procedure |
| SL PRS Sequence | Type 1 LBT | 810 in FIG. 8A | Type 2C LBT |
| #1 PRS_t(sqn1) | | | |
| 812 in FIG. 8A | | | |
| SL PRS Sequence | 25 us LBT | 820 in FIG. 8B | 25 us LBT |
| #2 PRS_t(sqn2) | | | |
| 822 in FIG. 8B | | | |
| SL PRS Sequence | 25 us LBT | 830 in FIG. 8C | Type 1 LBT |
| #3 PRS_t(sqn3) | | | |
| 832 in FIG. 8C | | | |

FIG. 8A illustrates an example of a frame structure 810 for the transmission of the first sidelink PRS sequence (PRS_t) with the Type 1 LBT procedure succeeding at the first device 110. In this example, the first device 110 may transmit a first sidelink PRS sequence that includes a SL PRS sequence #1 (PRS_t(sqn1)) 812, and the second device 120 transmits a second sidelink PRS sequence 814 (e.g., PRS_s).

As shown, a symbol #1 of a slot t₁ is a starting symbol for the transmission of the first PRS sequence #1 (PRS_t(sqn1)) 812. A transmission duration of the first PRS sequence #1 (PRS_t(sqn1)) 812 may last multiple symbols. The symbol #1 may be used for automatic gain control (AGC). Alternatively, part of the symbol #1 (i.e., AGC (PRS_t)) may be used for AGC.

In a symbol #2 of the slot t₁, the first device 110 transmits the first PRS sequence #1 (PRS_t(sqn1)) 812 which is used for sequence detection and timing estimation at the second device 120.

A symbol #3 of the slot t₁ is used to occupy the channel, which leaves more time for the second device 120 to finish the sequence detection and then operate accordingly. The symbols #2 and #3 may be buffered and combined together by the second device 120 for ranging or positioning related estimation such as timing estimation to improve estimation performance.

The first part of a symbol #4 of the slot t₁ is used to occupy the channel so as to provide a gap between the transmission of the first PRS sequence #1 (PRS_t(sqn1)) 812 and the transmission of the second PRS sequence (PRS_s) 814 be less than 16 us. This prevents a third party accessing the channel and ensures the second PRS sequence (PRS_s) 814 to be transmitted sequentially. The transmission of the second PRS sequence (PRS_s) 814 from the second device 120 occupies symbols #5 and #6 of the slot t₁.

The signal transmitted from the first device in the first part of the symbol #4 can be repetition of the same part of symbol #3. Alternatively, the signal transmitted from the first device in the first part of the symbol #4 can be constructed based on the first PRS sequence #1 (PRS_t(sqn1)). Alternatively, the signal transmitted from the first device in the first part of the symbol #4 can be any signal.

If the first PRS sequence #1 (PRS_t(sqn1)) 812 is detected by the second device 120, the second device 120 may determine that the Type 1 LBT procedure was performed by the first device 110 for the transmission of the first PRS sequence #1 (PRS_t(sqn1)) 812. In addition, the second device 120 may determine that the frame structure 810 is used for the transmission of the first PRS sequence #1 (PRS_t(sqn1)) 812. Based on the frame structure 810, the second device 120 may determine that the gap between the transmission of the first PRS sequence #1 (PRS_t(sqn1)) 812 and the transmission of the second PRS sequence (PRS_s) 814 is less than 16 us. In turn, the second device 120 may determine that a Type 2C LBT procedure is to be performed before the symbol #5 by the second device 120 for the transmission of the second PRS sequence (PRS_s) 814 to the first device 110.

FIG. 8B illustrates an example of a frame structure 820 for the transmission of the first sidelink PRS sequence with the 25 us LBT procedure succeeding at the first device 110. In this example, the first device 110 transmits a first sidelink PRS sequence #2 (PRS_t(sqn2)) 822, and the second device 120 transmits a second sidelink PRS sequence (PRS_s) 824.

As shown, if the first PRS sequence #2 (PRS_t(sqn2)) 822 is detected by the second device 120, the second device 120 may determine that the 25 us LBT procedure was performed by the first device 110 for the transmission of the first PRS sequence #2 (PRS_t(sqn2)) 822. In addition, the second device 120 may determine that the frame structure 820 is used for the transmission of the first PRS sequence #2 (PRS_t(sqn2)) 822. Based on the frame structure 820, the second device 120 may determine that the gap between the transmission of the first PRS sequence #2 (PRS_t(sqn2)) 822 and the transmission of the second PRS sequence 824 is greater than 25 us. In turn, the second device 120 may determine that a 25 us LBT procedure is to be performed before the symbol #5 by the second device 120 for the transmission of the second PRS sequence 824 to the first device 110.

The signal transmitted from the first device 110 in the first part of the symbol #4 can be repetition of the same part of symbol #3. Alternatively, the signal transmitted from the first device 110 in the first part of the symbol #4 can be constructed based on the first PRS sequence. Alternatively, the signal transmitted from the first device in the first part of the symbol #4 can be any signal.

FIG. 8C illustrates an example of a frame structure 830 for the transmission of the first sidelink PRS sequence with the 25 us LBT procedure succeeding at the first device 110. In this example, the first device 110 transmits a first sidelink PRS sequence #3 (PRS_t(sqn3)) 832, and the second device 120 transmits a second sidelink PRS sequence (PRS_s) 834.

As shown, if the first PRS sequence #3 (PRS_t(sqn3)) 832 is detected by the second device 120, the second device 120 may determine that the 25 us LBT procedure was performed by the first device 110 for the transmission of the first PRS sequence #3 (PRS_t(sqn3)) 832. In addition, the second device 120 may determine that the frame structure 830 is used for the transmission of the first PRS sequence #3 (PRS_t(sqn3)) 832. Based on the frame structure 830, the second device 120 may determine that the gap between the transmission of the first PRS sequence #3 (PRS_t(sqn3)) 832 and the transmission of the second PRS sequence (PRS_s) 834 includes two symbols. Because the more gap time are intentionally left for the second device 120, the second device 120 may determine that a Type 1 LBT procedure is to be performed before the symbol #5 by the second device 120 for the transmission of the second PRS sequence 834 to the first device 110.

It will be understood that the first PRS sequences 812, 822 and 832 may be different from each other, and the second PRS sequences (PRS_s) 814, 824 and 834 may be different from or identical to each other.

FIG. 9 illustrates a flowchart of an example method 900 in accordance with some implementations of the present disclosure. In some implementations, the method 900 can be implemented at a device, such as the first device 110 or the second device 120 as shown in FIG. 1. For the purpose of discussion, the method 900 will be described with reference to FIG. 1 as performed by the first device 110 without loss of generality.

At block 910, the first device 110 may perform a first type LBT procedure in an unlicensed band.

At block 920, in response to a successful performing of the first type LBT procedure, the first device 110 may transmit, to the second device 120, a first sidelink PRS sequence (PRS_t) in the unlicensed band for ranging between the first device 110 and the second device 120, and/or for positioning of the first device 110. The first sidelink PRS sequence (PRS_t) may be associated with the first type LBT procedure and/or a second type LBT procedure to be performed by the second device 120 for transmitting a second sidelink PRS sequence (PRS_s) in the unlicensed band to the first device 110 for the ranging or the positioning.

In some implementations the first device 110 may communicate with the second device 120, rest of sidelink signals or channels in a licensed band for the ranging or the positioning.

In some implementations the first device 110 may apply the first sidelink PRS sequence based on the first type LBT procedure.

In some implementations the second type LBT procedure may be applied by the second device 120 based on the first type LBT procedure.

In some implementations the first sidelink PRS sequence may be indicative of the first type LBT procedure and the second type LBT procedure.

In some implementations, performing the first type LBT procedure may include: performing the first type LBT procedure when it is determined that a third type LBT procedure cannot be successfully completed before the transmission of the first sidelink PRS sequence (PRS_t). The third type LBT procedure being different from the first type LBT procedure.

In some implementations, each of the first type LBT procedure and the second type LBT procedure being a 25 us LBT procedure, and the third type LBT procedure being a Type 1 LBT procedure.

In some implementations, the first type LBT procedure being a 25 us LBT procedure, and each of the second type LBT procedure and the third type LBT procedure being a Type 1 LBT procedure.

In some implementations, each of the first type LBT procedure and the second type LBT procedure being a Type 2A LBT procedure.

In some implementations, the first type LBT procedure being a Type 1 LBT procedure, and the second type LBT procedure being a Type 2C LBT procedure.

In some implementations, the method 900 further includes: receiving, from a third device 130, information about a first mapping among the first sidelink PRS sequence (PRS_t), the first type LBT procedure and the second type LBT procedure.

In some implementations, the first device 110 being an initiating device, the second device 120 being a responding device and the third device 130 being one of a network node and a core network node for the ranging or the positioning.

In some implementations, a first mapping among the first sidelink PRS sequence (PRS_t), the first type LBT procedure and the second type LBT procedure is predefined.

In some implementations, the first sidelink PRS sequence (PRS_t) is associated with a frame structure for the transmission of the first sidelink PRS sequence (PRS_t), and the frame structure is associated with the second type LBT procedure.

In some implementations, the method 900 further includes: prior to the transmitting to the second device 120 the first sidelink PRS sequence (PRS_t), transmitting, to the second device 120, information about at least one of the following: a first resource reservation for the transmission of the first sidelink PRS sequence (PRS_t), a second resource reservation for the transmission of the second sidelink PRS sequence (PRS_s) and a first mapping among the first sidelink PRS sequence (PRS_t), the first type LBT procedure and the second type LBT procedure.

In some implementations, transmitting the information about at least one of the first resource reservation and the second resource reservation includes: transmitting the information in one of the following: SCI carried in a PSCCH or PSSCH, or a MAC CE carried in the PSSCH.

In some implementations, the first resource reservation indicates at least one of the following: a starting symbol for the transmission of the first sidelink PRS sequence (PRS_t), or a duration of the transmission of the first sidelink PRS sequence (PRS_t).

In some implementations, the second resource reservation indicates at least one of the following: a starting symbol for the transmission of the second sidelink PRS sequence (PRS_s), or a duration of the transmission of the second sidelink PRS sequence (PRS_s).

In some implementations, the method 900 further includes: transmitting, to the second device 120, sharing information about COT.

In some implementations, the information about at least one of the first resource reservation and the second resource reservation is transmitted to the second device 120 in licensed band.

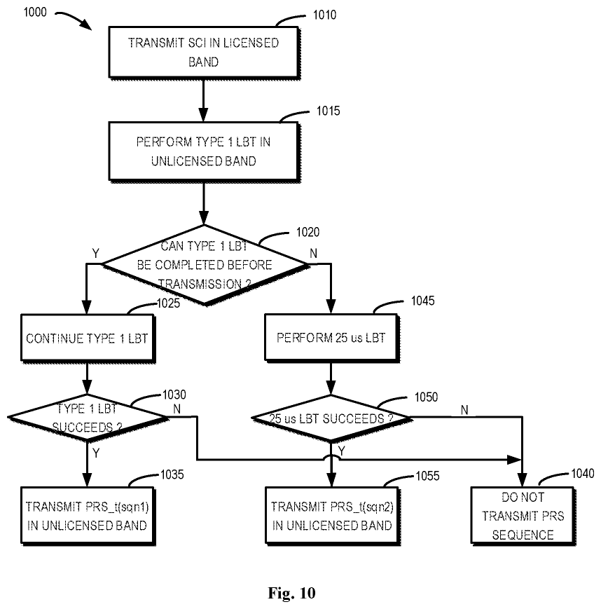

FIG. 10 illustrates a flowchart of an example method 1000 in accordance with some implementations of the present disclosure. The example method 1000 may be considered as an example implementation of the method 900. In some implementations, the method 1000 can be implemented at a device, such as the first device 110 or the second device 120 as shown in FIG. 1. For the purpose of discussion, the method 1000 will be described with reference to FIG. 1 as performed by the first device 110 without loss of generality.

At block 1010, the first device 110 transmits sidelink control information (SCI) in licensed band. The SCI may include configuration information about at least one of the following: a first resource reservation for the transmission of the first sidelink PRS sequence (PRS_t), or a second resource reservation for the transmission of the second sidelink PRS sequence (PRS_s). In addition, the SCI may also include information about the first mapping among the first sidelink PRS sequence (PRS_t), the first type LBT procedure and the second type LBT procedure.

At block 1015, the first device 110 may perform the Type 1 LBT procedure in unlicensed band.

At block 1020, the first device 110 determines whether the Type 1 LBT procedure may be completed successfully before transmission of the sidelink PRS sequence #1 (i.e., first PRS sequence #1 (PRS_t(sqn1)) 812).

If the Type 1 LBT procedure can be completed successfully before the transmission of the sidelink PRS sequence #1 (i.e., first PRS sequence #1 (PRS_t(sqn1)) 812), the first device 110 continues the Type 1 LBT procedure at block 1025.

At block 1030, the first device 110 determines whether the Type 1 LBT procedure succeeds. If the Type 1 LBT procedure succeeds, the first device 110 transmits, at block 1035, the sidelink PRS sequence #1 (i.e., first PRS sequence #1 (PRS_t(sqn1)) 812) in unlicensed band to the second device 120. On the other hand, if the Type 1 LBT procedure does not succeed, the first device 110 does not transmit any sidelink PRS sequence at block 1040.

At block 1020, if the first device 110 determines that the Type 1 LBT procedure cannot be completed successfully before the transmission of the sidelink PRS sequence #1 (i.e., first PRS sequence #1 (PRS_t(sqn1)) 812), the first device 110 performs, at block 1045, the 25 us LBT procedure in unlicensed band.

At block 1050, the first device 110 determines whether the 25 us LBT procedure succeeds. If the 25 us LBT procedure succeeds, the first device 110 transmits, at block 1055, the sidelink PRS sequence #2 (i.e., first PRS sequence #2 (PRS_t(sqn2)) 822) in unlicensed band to the second device 120. On the other hand, if the 25 us LBT procedure does not succeed, the first device 110 does not transmit any sidelink PRS sequence at block 1040.

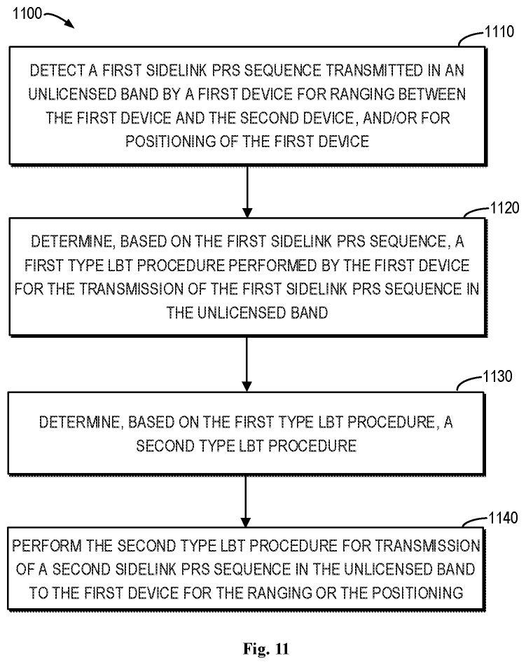

FIG. 11 illustrates a flowchart of an example method 1100 in accordance with some implementations of the present disclosure. In some implementations, the method 1100 can be implemented at a device, such as the first device 110 or the second device 120 as shown in FIG. 1. For the purpose of discussion, the method 1100 will be described with reference to FIG. 1 as performed by the second device 120 without loss of generality.

At block 1110, the second device 120 detect a first sidelink PRS sequence (PRS_t) transmitted in an unlicensed band by a first device 110 for ranging between the first device 110 and the second device 120, and/or for positioning of the first device 110.

At block 1120, the second device 120 determines, based on the first sidelink PRS sequence (PRS_t), a first type LBT procedure performed by the first device 110 for the transmission of the first sidelink PRS sequence (PRS_t) in the unlicensed band.

At block 1130, the second device 120 determines, based on the first type LBT procedure, a second type LBT procedure.

At block 1140, the second device 120 performs the second type LBT procedure for transmission of a second sidelink PRS sequence (PRS_s) in unlicensed band to the first device 110 for the ranging or the positioning.

In some implementations, the second device 120 may communicate with the first device 110, rest of sidelink signals or channels in a licensed band for the ranging or the positioning.

In some implementations the second device 120 may apply the second sidelink PRS sequence based on the second type LBT procedure.

In some implementations the second device 120 may apply the second type LBT procedure based on the first type LBT procedure.

In some implementations, the method 1100 further includes: receiving, from the first device 110 or a third device 130, information about a first mapping among the first sidelink PRS sequence (PRS_t), the first type LBT procedure and the second type LBT procedure.

In some implementations, the first device 110 being an initiating device, the second device 120 being a responding device and the third device 130 being one of a network node and a core network node, for the ranging or the positioning.

In some implementations, receiving the information about the first mapping includes receiving the information in one of the following: SCI carried in a PSCCH or PSSCH in licensed band, or a MAC CE carried in the PSSCH in licensed band.

In some implementations, the first mapping among the first sidelink PRS sequence (PRS_t), the first type LBT procedure and the second type LBT procedure are predefined.

In some implementations, the first type LBT procedure is a Type 1 LBT procedure, and the second type LBT procedure is a Type 2C LBT procedure.

In some implementations, each of the first type LBT procedure and the second type LBT procedure being a Type 2A LBT procedure.

In some implementations, the first sidelink PRS sequence (PRS_t) is associated with a frame structure for transmission of the first sidelink PRS sequence (PRS_t), and the frame structure is associated with the second type LBT procedure. In such implementations, determining the frame structure includes: determining the frame structure based on the first sidelink PRS sequence (PRS_t). In such implementations, determining the second type LBT procedure to be performed includes: determining, based on the first type LBT procedure and the frame structure, the second type LBT procedure to be performed.

In some implementations, the method 1100 further includes: receiving, from the first device 110, information about a first resource reservation for the transmission of the first sidelink PRS sequence (PRS_t). In such implementations, detecting the first sidelink PRS sequence (PRS_t) includes: detecting the first sidelink PRS sequence (PRS_t) based on the information.

In some implementations, the first resource reservation indicates at least one of the following: a starting symbol for the transmission of the first sidelink PRS sequence (PRS_t), or a duration of the transmission of the first sidelink PRS sequence (PRS_t).

In some implementations, receiving the information about the first resource reservation includes: receiving the information about the first resource reservation in one of the following: SCI carried in a PSCCH or PSSCH in licensed band, or a MAC CE carried in the PSSCH in licensed band.

In some implementations, the method 1100 further includes: receiving, from the first device 110, information about a second resource reservation for the transmission of the second sidelink PRS sequence (PRS_s). In such implementations, transmitting the second sidelink PRS sequence (PRS_s) includes: transmitting the second sidelink PRS sequence (PRS_s) based on the information.

In some implementations, the second resource reservation indicates at least one of the following: a starting symbol for the transmission of the second sidelink PRS sequence (PRS_s), or a duration of the transmission of the second sidelink PRS sequence (PRS_s).

In some implementations, receiving the information about the second resource reservation includes: receiving the information about the second resource reservation in one of the following: SCI carried in a PSCCH or PSSCH in licensed band, or a MAC CE carried in the PSSCH in licensed band.

In some implementations, the method 1100 further includes: receiving, from the first device 110, sharing information about COT; and performing the second type LBT procedure based on the sharing information.

It shall be understood that implementations of the present disclosure which have been described with reference to FIGS. 1 to 8 are also applied to the methods 900, 1000 and 1100. The details of the implementations are omitted for brevity.

In some example implementations, an apparatus capable of performing any of the method 900 (for example, the first device 110) may include means for performing the respective steps of the method 900. The means may be implemented in any suitable form. For example, the means may be implemented in a circuitry or software module.

In some example implementations, the apparatus includes: means for performing. by a first device 110, a first type LBT procedure in an unlicensed band; and means for transmitting, to a second device 120, a first sidelink PRS sequence (PRS_t) in the unlicensed band for ranging between the first device 110 and the second device 120, and/or for positioning of the first device 110, in response to a successful performing of the first type LBT procedure, In some implementations the first sidelink PRS sequence is associated with the first type LBT procedure and/or a second type LBT procedure to be performed by the second device 120 for transmitting a second sidelink PRS sequence (PRS_s) in the unlicensed band to the first device 110 for the ranging or the positioning.

In some implementations, the apparatus further comprises: means for communicating with the second device 120, rest of sidelink signals or channels in a licensed band for the ranging or the positioning.

In some implementations, the means for transmitting the first sidelink PRS sequence (PRS_t) comprises means for applying the first sidelink PRS sequence based on the first type LBT procedure.

In some implementations, the second type LBT procedure may be applied by the second device 120 based on the first type LBT procedure.

In some implementations, the first sidelink PRS sequence may be indicative of the first type LBT procedure and the second type LBT procedure.

In some implementations, the means for performing the first type LBT procedure may include: means for performing the first type LBT procedure when it is determined that a third type LBT procedure cannot be successfully completed before the transmission of the first sidelink PRS sequence (PRS_t). The third type LBT procedure being different from the first type LBT procedure.

In some implementations, each of the first type LBT procedure and the second type LBT procedure being a 25 us LBT procedure, and the third type LBT procedure being a Type 1 LBT procedure.

In some implementations, the first type LBT procedure being a 25 us LBT procedure, and each of the second type LBT procedure and the third type LBT procedure being a Type 1 LBT procedure.

In some implementations, each of the first type LBT procedure and the second type LBT procedure being a Type 2A LBT procedure.

In some implementations, the first type LBT procedure being a Type 1 LBT procedure, and the second type LBT procedure being a Type 2C LBT procedure.

In some implementations, the apparatus further includes: means for receiving, from a third device 130, information about a first mapping among the first sidelink PRS sequence (PRS_t), the first type LBT procedure and the second type LBT procedure.

In some implementations, the first device 110 being an initiating device, the second device 120 being a responding device and the third device 130 being one of a network node and a core network node, for the ranging or the positioning.

In some implementations, a first mapping among the first sidelink PRS sequence (PRS_t), the first type LBT procedure and the second type LBT procedure is predefined.

In some implementations, the first sidelink PRS sequence (PRS_t) is associated with a frame structure for the transmission of the first sidelink PRS sequence (PRS_t), and the frame structure is associated with the second type LBT procedure.

In some implementations, the apparatus further includes: prior to the transmitting to the second device 120 the first sidelink PRS sequence (PRS_t), means for transmitting, to the second device 120, information about at least one of the following: a first resource reservation for the transmission of the first sidelink PRS sequence (PRS_t), a second resource reservation for the transmission of the second sidelink PRS sequence (PRS_s) and a first mapping among the first sidelink PRS sequence (PRS_t), the first type LBT procedure and the second type LBT procedure.

In some implementations, the means for transmitting the information about at least one of the first resource reservation and the second resource reservation includes: means for transmitting the information in one of the following: SCI carried in a PSCCH or PSSCH, or a MAC CE carried in the PSSCH.

In some implementations, the first resource reservation indicates at least one of the following: a starting symbol for the transmission of the first sidelink PRS sequence (PRS_t), or a duration of the transmission of the first sidelink PRS sequence (PRS_t).

In some implementations, the second resource reservation indicates at least one of the following: a starting symbol for the transmission of the second sidelink PRS sequence (PRS_s), or a duration of the transmission of the second sidelink PRS sequence (PRS_s).

In some implementations, the apparatus further includes: means for transmitting, to the second device 120, sharing information about COT.

In some implementations, the information about at least one of the first resource reservation and the second resource reservation is transmitted to the second device 120 in licensed band.

In some example implementations, an apparatus capable of performing any of the method 1100 (for example, the second device 120) may include means for performing the respective steps of the method 1100. The means may be implemented in any suitable form. For example, the means may be implemented in a circuitry or software module.

In some example implementations, the apparatus includes: means for detecting, by a second device 120, a first sidelink PRS sequence (PRS_t) transmitted by a first device 110 in an unlicensed band for ranging between the first device 110 and the second device 120, and/or for positioning of the first device 110; means for determining, based on the first sidelink PRS sequence, a first type LBT procedure performed by the first device 110 for the transmission of the first sidelink PRS sequence; means for determining, based on the first type LBT procedure, a second type LBT procedure; and means for performing the second type LBT procedure for transmission of a second sidelink PRS sequence (PRS_s) in the unlicensed band to the first device 110 for the ranging or the positioning.

In some implementations, the apparatus further includes: means for communicating with the first device 110, rest of sidelink signals or channels in a licensed band for the ranging or the positioning.

In some implementations, the apparatus further includes: means for applying the second sidelink PRS sequence based on the second type LBT procedure.

In some implementations, the means for performing the second type LBT procedure includes means for applying the second type LBT procedure based on the first type LBT procedure.

In some implementations, the apparatus further includes: means for receiving, from the first device 110 or a third device 130, information about a first mapping among the first sidelink PRS sequence (PRS_t), the first type LBT procedure and the second type LBT procedure.

In some implementations, the first device 110 being an initiating device, the second device 120 being a responding device and the third device 130 being one of a network node and a core network node, for the ranging or the positioning.

In some implementations, the means for receiving the information about the first mapping includes means for receiving the information in one of the following: SCI carried in a PSCCH or PSSCH in licensed band, or a MAC CE carried in the PSSCH in licensed band.

In some implementations, the first mapping among the first sidelink PRS sequence (PRS_t), the first type LBT procedure and the second type LBT procedure are predefined.

In some implementations, the first type LBT procedure is a Type 1 LBT procedure, and the second type LBT procedure is a Type 2C LBT procedure.

In some implementations, each of the first type LBT procedure and the second type LBT procedure being a Type 2A LBT procedure.

In some implementations, the first sidelink PRS sequence (PRS_t) is associated with a frame structure for transmission of the first sidelink PRS sequence (PRS_t), and the frame structure is associated with the second type LBT procedure. In such implementations, the means for determining the frame structure includes: means for determining the frame structure based on the first sidelink PRS sequence (PRS_t). In such implementations, the means for determining the second type LBT procedure to be performed includes: means for determining, based on the first type LBT procedure and the frame structure, the second type LBT procedure to be performed.

In some implementations, the apparatus further includes: means for receiving. from the first device 110, information about a first resource reservation for the transmission of the first sidelink PRS sequence (PRS_t). In such implementations, the means for detecting the first sidelink PRS sequence (PRS_t) includes: means for detecting the first sidelink PRS sequence (PRS_t) based on the information.

In some implementations, the first resource reservation indicates at least one of the following: a starting symbol for the transmission of the first sidelink PRS sequence (PRS_t), or a duration of the transmission of the first sidelink PRS sequence (PRS_t).

In some implementations, the means for receiving the information about the first resource reservation includes: means for receiving the information about the first resource reservation in one of the following: SCI carried in a PSCCH or PSSCH in licensed band, or a MAC CE carried in the PSSCH in licensed band.

In some implementations, the apparatus further includes: means for receiving, from the first device 110, information about a second resource reservation for the transmission of the second sidelink PRS sequence (PRS_s). In such implementations, the means for transmitting the second sidelink PRS sequence (PRS_s) includes: means for transmitting the second sidelink PRS sequence (PRS_s) based on the information.

In some implementations, the second resource reservation indicates at least one of the following: a starting symbol for the transmission of the second sidelink PRS sequence (PRS_s), or a duration of the transmission of the second sidelink PRS sequence (PRS_s).

In some implementations, the means for receiving the information about the second resource reservation includes: means for receiving the information about the second resource reservation in one of the following: SCI carried in a PSCCH or PSSCH in licensed band, or a MAC CE carried in the PSSCH in licensed band.

In some implementations, the apparatus further includes: means for receiving, from the first device 110, sharing information about COT; and the means for performing the second type LBT procedure comprises means for performing the second type LBT procedure based on the sharing information.

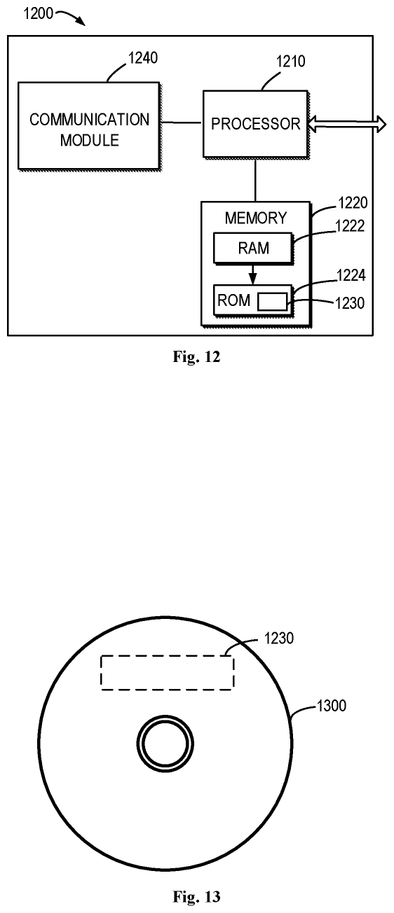

FIG. 12 is a simplified block diagram of a device 1200 that is suitable for implementing embodiments of the present disclosure. The device 1200 may be provided to implement the communication device, for example, the first device 110 or the second device 120 as shown in FIG. 1. As shown, the device 1200 includes one or more processors 1210, one or more memories 1220 coupled to the processor 1210, and one or more communication modules 1240 coupled to the processor 1210.

The communication module 1240 is for bidirectional communications. The communication module 1240 has at least one antenna to facilitate communication. The communication interface may represent any interface that is necessary for communication with other network elements.

The processor 1210 may be of any type suitable to the local technical network and may include one or more of the following: general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The memory 1220 may include one or more non-volatile memories and one or more volatile memories. Examples of the non-volatile memories include, but are not limited to, a Read Only Memory (ROM) 1224, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1222 and other volatile memories that will not last in the power-down duration.

A computer program 1230 includes computer executable instructions that are executed by the associated processor 1210. The program 1230 may be stored in the ROM 1224. The processor 1210 may perform any suitable actions and processing by loading the program 1230 into the RAM 1222.

The embodiments of the present disclosure may be implemented by means of the program 1230 so that the device 1200 may perform any process of the disclosure as discussed with reference to FIGS. 1 to 11. The embodiments of the present disclosure may also be implemented by hardware or by a combination of software and hardware.

In some example embodiments, the program 1230 may be tangibly contained in a computer readable medium which may be included in the device 1200 (such as in the memory 1220) or other storage devices that are accessible by the device 1200. The device 1200 may load the program 1230 from the computer readable medium to the RAM 1222 for execution. The computer readable medium may include any types of tangible non-volatile storage, such as ROM, EPROM, a flash memory, a hard disk, CD, DVD, and the like. FIG. 13 shows an example of the computer readable medium 1300 in form of CD or DVD. The computer readable medium has the program 1230 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 900, 1000 and 1100 as described above with reference to FIGS. 9, 10 and 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-44. (canceled)

45. A first device for wireless communication, comprising:
at least one processor; and
at least one memory including computer program code;
wherein the at least one memory and the computer program code are configured to, with the at least one processor, cause the first device to:
perform a first type listen before talk (LBT) procedure in an unlicensed band; and
in response to a successful performing of the first type LBT procedure, transmit, to a second device, a first sidelink positioning reference signal (PRS) sequence in the unlicensed band for ranging between the first device and the second device, and/or for positioning of the first device, wherein the first sidelink PRS sequence is associated with the first type LBT procedure and/or a second type LBT procedure to be performed by the second device for transmitting a second sidelink PRS sequence in the unlicensed band to the first device for the ranging or the positioning.

46. The first device of claim 45, wherein the first device is caused to perform at least one or more of:
communicate with the second device, rest of sidelink signals or channels in a licensed band for the ranging or the positioning;
apply the first sidelink PRS sequence based on the first type LBT procedure; or receive, from a third device, information about a first mapping among the first sidelink PRS sequence, the first type LBT procedure and the second type LBT procedure.

47. The first device of claim 45, wherein the second type LBT procedure is applied by the second device based on the first type LBT procedure.

48. The first device of claim 45, wherein the first sidelink PRS sequence is indicative of the first type LBT procedure and the second type LBT procedure.

49. The first device of claim 45, wherein the first device is caused to perform the first type LBT procedure when it is determined that a third type LBT procedure in the unlicensed band cannot be successfully completed before the transmission of the first sidelink PRS sequence, the third type LBT procedure being different from the first type LBT procedure.

50. The first device of claim 49, wherein:
each of the first type LBT procedure being a 25 us LBT procedure;
the second type LBT procedure being one of a 25 us LBT procedure or a Type 1 LBT procedure; and
the third type LBT procedure being a Type 1 LBT procedure.

51. The first device of claim 45, wherein each of the first type LBT procedure and the second type LBT procedure being a Type 2A LBT procedure.

52. The first device of claim 45, wherein the first type LBT procedure being a Type 1 LBT procedure, and the second type LBT procedure being a Type 2C LBT procedure.

53. The first device of claim 46, wherein the first device being an initiating device, the second device being a responding device and the third device being one of a network node and a core network node, for the ranging or the positioning.

54. The first device of claim 45, wherein a first mapping among the first sidelink PRS sequence, the first type LBT procedure and the second type LBT procedure is predefined.

55. The first device of claim 45, wherein the first sidelink PRS sequence is associated with a frame structure for transmission of the first sidelink PRS sequence, and the frame structure is associated with the second type LBT procedure.

56. The first device of claim 45, wherein prior to transmitting to the second device the first sidelink PRS sequence, the first device is further caused to:
transmit, to the second device, information about at least one of the following:
a first resource reservation for the transmission of the first sidelink PRS sequence, or
a second resource reservation for the transmission of the second sidelink PRS sequence, and
a first mapping among the first sidelink PRS sequence, the first type LBT procedure and the second type LBT procedure.

57. The first device of claim 56, wherein the first device is caused to transmit the information in one or more of the following:
sidelink control information (SCI) carried in a physical sidelink control channel (PSCCH) or physical sidelink shared channel (PSSCH),
a medium access control control element (MAC CE) carried in the PSSCH; or
transmit in a licensed band, to the second device, sharing information about channel occupancy time (COT).

58. The first device of claim 56, wherein:
the first resource reservation indicates at least one of the following:
a starting symbol for the transmission of the first sidelink PRS sequence, or
a duration of the transmission of the first sidelink PRS sequence; and
the second resource reservation indicates at least one of the following:
a starting symbol for the transmission of the second sidelink PRS sequence, or
a duration of the transmission of the second sidelink PRS sequence.

59. A second device for wireless communication, comprising:
at least one processor; and
at least one memory including computer program code;
wherein the at least one memory and the computer program code are configured to, with the at least one processor, cause the second device to:
detect a first sidelink positioning reference signal (PRS) sequence transmitted in an unlicensed band by a first device for ranging between the first device and the second device, and/or for positioning of the first device;
determine, based on the first sidelink PRS sequence, a first type listen before talk (LBT) procedure performed by the first device for the transmission of the first sidelink PRS sequence in the unlicensed band;
determine, based on the first type LBT procedure, a second type LBT procedure; and
perform the second type LBT procedure for transmission of a second sidelink PRS sequence in the unlicensed band to the first device for the ranging or the positioning.

60. The second device of claim 59, wherein the first sidelink PRS sequence is associated with a frame structure for transmission of the first sidelink PRS sequence, and the frame structure is associated with the second type LBT procedure;
wherein the second device is further caused to determine the frame structure based on the first sidelink PRS sequence; and
wherein the second device is caused to determine, based on the first type LBT procedure and the frame structure, the second type LBT procedure to be performed.

61. The second device of claim 59, wherein the second device is further caused to:
receive, from the first device, information about a first resource reservation for the transmission of the first sidelink PRS sequence; and
wherein the second device is caused to detect the first sidelink PRS sequence based on the information.

62. The second device of claim 61, wherein the first resource reservation indicates at least one of the following:
a starting symbol for the transmission of the first sidelink PRS sequence, or
a duration of the transmission of the first sidelink PRS sequence.

63. The second device of claim 61, whereinthe second device is caused to perform one or more of:
receive the information about the first resource reservation in one of the following:
sidelink control information (SCI) carried in a physical sidelink control channel (PSCCH) or physical sidelink shared channel (PSSCH) in licensed band, or a medium access control control element (MAC CE) carried in the PSSCH in licensed band; or
receive, from the first device, information about a second resource reservation for the transmission of the second sidelink PRS sequence; and wherein the second device is caused to transmit the second sidelink PRS sequence based on the information.

64. The second device of claim 63, wherein:
the second resource reservation indicates at least one of the following:
a starting symbol for the transmission of the second sidelink PRS sequence, or
a duration of the transmission of the second sidelink PRS sequence; or
the second device is caused to receiving the information about the second resource reservation in one of the following:
sidelink control information (SCI) carried in a physical sidelink control channel (PSCCH) or physical sidelink shared channel (PSSCH) in licensed band, or
a medium access control control element (MAC CE) carried in the PSSCH in licensed band.
